(19) United States
(12) Patent Application Publication
(10) Pub. No.: US 2009/0235526 A1
(43) Pub. Date: Sep. 24, 2009

(54) Method for the manufacture of a welded blisk drum

(76) Inventors: Arno SECHERLING, Oberursel (DE); Matthias BIERTZ, Oberursel (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(21) Appl. No.: 12/382,513

(22) Filed: Mar. 18, 2009

(30) Foreign Application Priority Data
Mar. 18, 2008 (DE) 10 2008 014 726.7

(51) Int. Cl. B23P 15/04; B24B 1/00; C21D 7/06

(52) U.S. Cl. 29/889.7; 451/36; 72/53

(57) ABSTRACT

When manufacturing welded blisk drums for gas-turbine engines, two or more integrally bladed blisks are joined to a blisk drum by welding, with this drum being subsequently heat-treated. In the final processing step, the blisk blades are polished, with the blisk drum as a whole being immerged into a flowable, pasty abrasive medium, and with a relative movement between the blisk drum and the abrasive medium being generated by translation and/or vibration and/or rotation of the blisk drum or a tub containing the abrasive medium. In order to avoid changes in shape of the blade edges during polishing, relative movement in these areas is prevented by guiding elements. The blade edges may also be masked, or surplus material may be provided on the blade edges, which afterwards is removed during grinding.

This application claims priority to German Patent Application DE102008014725.7 filed Mar. 18, 2008, the entirety of which is incorporated by reference herein.

The present invention relates to a method for the manufacture of a blisk drum in which two or more pre-manufactured blisks are joined by welding and the blisk drum so produced is subsequently subjected to heat treatment and the blade surfaces are polished in the final processing step.

Under the aspects of reliability, weight reduction, performance increase and service life, gas-turbine rotors, and in particular the rotors of the compressors of gas-turbine engines, are provided with a blading which is integrally formed on the annular periphery of a disk or of a ring. Such components are termed “blisks”, with the term “blisk” being a shortened form of “blade integrated disk”. As is generally known, blisks are manufactured by welding, in particular friction welding, separately produced blades to the peripheral surface of the preferably forged disk or by a cutting and/or chemical stock removal process for forming the blades from the solid material, this process starting at the outer peripheral surface of the disk. In the final step, the blades are finish-machined by smoothing processes, for example by vibratory grinding in which the blisk is placed in a vibrating tub containing an abrasive medium and the blades are ground or polished, respectively, by the vibration-caused spiralling of the abrasive medium, with the surfaces of the blades thereafter having a roughness value (Rₐ) which essentially satisfies the in-service aerodynamic requirements of the gas turbine. If required, the blisk is subsequently subjected to an etching process. The joining of the individual blisks to a blisk drum, for example in a welding process, is followed by a heat treatment of entire blisk drum as well as by etching processes and a strengthening process, as a result of which the surface finish is significantly impaired and re-smoothing of the blade surfaces is required.

As is generally known, the blades on a blisk drum are smoothed with robots equipped with a polishing lance and controlled by a preset program. Polishing of the individual blades with polishing lances is time-consuming and cost-extensive. Furthermore, accessibility of the blade surfaces is restricted so that the requirements on aerodynamic efficiency cannot always be met.

A broad aspect of the present invention is to provide a method for the manufacture of a welded blisk drum such that the blisk blades satisfy high aerodynamic requirements both on the roughness of the side faces and on the leading edge and trailing edge as well as the edge extending on the blade tip while keeping the time and cost investment low.

The basic idea of the present invention is to immerse a blisk drum, which has been welded and heat-treated after welding, as a whole in a pasty, flowable abrasive medium and to grind the blisk blades exclusively on the pressure and suction sides by a relative movement generated between the blisk drum and the abrasive medium, while the leading edge and the trailing edge as well as the edge extending on the blade tip are either masked or relative movement of the abrasive medium in the edge areas is avoided and the abrasive medium primarily guided to the blade surfaces to be ground in that guiding elements are provided in the abrasive medium. This enables all blade surfaces of a blisk drum to be polished in one operation with low time and cost investment while preserving the aerodynamically favorable shape of the blade edges as already produced during manufacture of the individual blisks.

Alternatively, a certain amount of excessive stock can be provided on the blade edges during manufacture of the individual blisks to take account of the material removed on the blade edges by the action of the abrasive medium, thereby preserving the aerodynamically most favorable shape of the blade edges despite being treated with the abrasive medium.

Relative movement between the abrasive medium and the blisk blades is obtained by vibration of the tub containing the blisk drum retained therein and the abrasive medium. However, the blisk can also translatorily or rotationally move in the abrasive medium. A combination of the above mentioned modes of movement is also possible, with both the blisk drum and the tub containing the abrasive medium being movable. The blisk drum can be vertically or horizontally arranged in the tub containing the abrasive medium. Prior to be being placed into the abrasive medium, the open end faces of the blisk drum are closed.

In a further development of the present invention, an abrasive paste with abrasive carriers embedded therein is used as abrasive medium to increase the pressure build-up on the blade surfaces to be ground.

In accordance with another feature of the present invention, the surface of the blisk drum is, upon heat treatment, first treated with an etchant to reduce surface roughness caused by heat treatment. Shot peening the blade surfaces after etching increases the strength of the blades and reduces the hazard of stress corrosion cracking. Shot peening increases the roughness of the blade surfaces. Subsequent polishing of the entire blisk drum in the abrasive medium will, however, reduce the roughness of the blade surfaces to a value which satisfies highest aerodynamic requirements.

One embodiment of the present invention is more fully described in the following:

In a first process step, the annular disks with integrally formed-on or shaped blades, the so-called blisks, are produced in the respective size required for the individual stages of the compressor of a gas turbine and subsequently joined to a multi-stage blisk drum by welding. At his stage, the roughness of the blade surfaces has a value (Rₐ) of approx. 0.25. Subsequently, the blisk drum is heat-treated to eliminate the stresses caused by welding. In a following chemical treatment in an etchant, in which a brittle surface layer caused by the heat treatment is removed, the surface roughness is increased to a roughness value Rₐ of approx. 0.4. In the next process step, the blades of the blisk drum are shot-peened in a special process, which does not affect the shape of the leading edge, the trailing edge and the blade tip edge, to increase the strength of the blades and minimize the hazard of cracking by inducing residual compressive stresses into the both-side surface layers, thereby increasing the service life of the blades. However, shot peening produces a multitude of minute, cup-like depressions in the blade surfaces so that the roughness of the blade surface is increased to a value Rₐ of approx. 0.7. Shot peening is followed by vibratory grinding of all blades of the blisk drum, as a result of which the blade surfaces have an aerodynamically advantageous roughness value of Rₐ≦0.25 and the shape the blade edges satisfies the aerodynamical requirements imposed thereon.

The above mentioned vibratory grinding process of the blade surfaces is accomplished in a tub dimensioned in accordance with the shape and the size of the blisk drum and filled with a pasty, flowable abrasive medium by relative movement between the abrasive medium and the blade surfaces. The blisk drum, which is closed at the end faces, immerses completely into the abrasive medium. The relative movement between the abrasive medium and the blade surfaces can be effected by vibration of the tub containing the abrasive medium and the blisk drum located, for example, vertically in the tub, with the abrasive medium, due to the vibration of the tub, performing a toroidal movement. However, it is also possible that the blisk drum is translatorily moved or rotated about its axis in the abrasive medium. Movement of the blade surfaces relative to the abrasive medium can also be effected by rotary movement of a blisk drum located horizontally in the tub. However, a combination of the above mentioned modes of movement of the blisk drum is also possible, i.e. vibration and/or translation and/or rotation.

The abrasive medium includes abrasive carriers embedded in an abrasive paste, with the combination of compact abrasive carriers and the abrasive, properly speaking, providing for the necessary pressure build-up at the surfaces to be ground and for optimum abrasive effect.

Guiding elements disposed in the abrasive medium enable the abrasive medium to be positively directed to the blade surfaces to be processed to obtain—exactly on the latter—the desired abrasive effect, while avoiding relative movement between the blade elements not to be processed, actually the blade edges, and the abrasive medium, thereby preserving the original shape of the blade edges. Alternatively, unwanted removal of material from the blade edges/blade tips can also be avoided by masking the latter. Thus, the blade tips of the blisk drum remain straight and sharp-edged while preserving a specified, preferably oval profile of the blade leading edges. The grinding process can, in a variant thereof, also be performed without masking the blade edges or without suppression of the relative movement on the blade edges if a certain—surplus—stock, which is identical with the stock removed during grinding, is already provided during manufacture of the individual blisks in the respective area, for example the blade leading edge, i.e. the blades are manufactured with oversize in the respective areas to take account of the unwanted removal of stock caused by the grinding process.

The method described in the above by way of example yields a blisk drum which satisfies highest aerodynamic requirements on the geometry of the blade edges and on the roughness of the blade surfaces and is producible with reduced time and cost investment. In accordance with the present example, welded blisk drums can be produced whose blades have

high strength and resistance to stress-corrosion cracking,

aerodynamically shaped leading and trailing edges and a sharp blade tip edge to ensure the required gap control and, finally,

blade side surfaces with an aerodynamically advantageous, low roughness value which, in the present example, is at Rₐ≦0.25.

What is claimed is:

1. A method for the manufacture of a blisk drum, comprising:
joining several pre-manufactured blisks by at least one of welding and other processes to form a blisk drum;
subsequently heat treating the blisk drum;
polishing the blade surfaces by inserting the blisk drum within a flowable, pasty abrasive medium and causing relative movement between the blisk drum and the abrasive medium, this relative movement being generated by at least one of vibration, translation and rotation of at least one of the blisk drum and a container containing the abrasive medium;
preventing excessive abrasive effect of the grinding medium in blade areas by at least one of providing guiding elements in the abrasive medium, masking the blade areas, and providing additional material in the blade areas during manufacture of the blisks to take account material removal expected during polishing.

2. The method of claim 1, and further comprising providing edges of the blisk blades with a final shape and dimensions prior to polishing and masking the edges prior to the polishing operation in the abrasive medium.

3. The method of claim 1, and further comprising providing an excess of material on the blade edges that exceeds a final shape removing the excess of material during at least one of the polishing operation and other processes.

4. The method of claim 1, and further comprising and further comprising controlling a polishing movement of the abrasive medium by a shape and arrangement of the guiding elements towards and along polishing areas, and reducing the polishing movement in other areas which are to be protected.

5. The method of claim 4, and further comprising closing open end faces of the blisk drum prior to being placed into the abrasive medium.

6. The method of claim 5, wherein the abrasive medium is an abrasive paste with abrasive carriers embedded therein, to build-up pressure on the surfaces to be ground.

7. The method of claim 6, and further comprising treating a surface of the blisk drum with an etchant upon heat treatment.

8. The method of claim 7, and further comprising at least one of shot peening the blisk drum after etching and subjecting the blisk drum to other surface-strengthening processes.

9. The method of claim 1, and further comprising closing open end faces of the blisk drum prior to being placed into the abrasive medium.

10. The method of claim 1, wherein the abrasive medium is an abrasive paste with abrasive carriers embedded therein, to build-up pressure on the surfaces to be ground.

11. The method of claim 1, and further comprising treating a surface of the blisk drum with an etchant upon heat treatment.

12. The method of claim 11, and further comprising at least one of shot peening the blisk drum after etching and subjecting the blisk drum to other surface-strengthening processes.
